(19) United States
(12) Patent Application Publication
(10) Pub. No.: US 2014/0054863 A1
(43) Pub. Date: Feb. 27, 2014

(54) SEAL ASSEMBLY FOR A TURBINE SYSTEM

(71) Applicants: Sendilkumaran Soundiramourty, Bangalore (IN); Ravi Shankar Venkata Kasibhotla, Bangalore (IN); Vignesh Radhakrishnan, Bangalore (IN)

(72) Inventors: Sendilkumaran Soundiramourty, Bangalore (IN); Ravi Shankar Venkata Kasibhotla, Bangalore (IN); Vignesh Radhakrishnan, Bangalore (IN)

(73) Assignee: GENERAL ELECTRIC COMPANY, Schenectady, NY (US)

(21) Appl. No.: 13/590,846

(22) Filed: Aug. 21, 2012

(51) Int. Cl. F16J 15/447

(52) U.S. Cl. 277/412

(57) ABSTRACT

A seal assembly for a turbine system includes a sealing strip having a forward surface and an aft surface, wherein the sealing strip is operably coupled to a first component and extends radially outwardly toward a second component for inhibiting a flow of fluid passing through a fluid path defined by the first component and the second component. Also included is at least one groove disposed within at least one of the forward surface and the aft surface of the sealing strip.

### BACKGROUND OF THE INVENTION

The subject matter disclosed herein relates to turbine systems, and more particularly to a seal assembly for such turbine systems.

Turbine systems, such as gas turbines, typically receive a supply of pressurized air from a compressor section and a supply of fuel. The pressurized air and fuel are mixed to form a combustible air/fuel mixture. The air/fuel mixture is then ignited and combusted to form hot gases that are directed into a turbine section. Thermal energy from the hot gases is converted to mechanical, rotational energy in a turbine section of the turbine system.

The hot gases are passed from the combustor into the turbine section through a transition duct or piece. Generally, an air duct that delivers cooling air from the compressor surrounds the transition piece. Unless internal surfaces are properly sealed, the hot gases may bypass the turbine section and enter into the air duct. This bypass or leakage flow does not produce any work and thus represents internal losses in the turbine system. The leakage flow generally passes between adjacent surfaces moving or rotating at variable speeds. Over time, clearances between the variable speed surfaces may increase due to internal rubbing, solid particle erosion, foreign object damage (FOD), and the like. Currently, many turbine systems employ labyrinth seals between the variable speed surfaces to limit the leakage flow. The labyrinth seals create multiple barriers that substantially limit the hot gases from entering into the cooling flow in the air duct.

### BRIEF DESCRIPTION OF THE INVENTION

According to one aspect of the invention, a seal assembly for a turbine system includes a sealing strip having a forward surface and an aft surface, wherein the sealing strip is operably coupled to a first component and extends radially outwardly toward a second component for inhibiting a flow of fluid passing through a fluid path defined by the first component and the second component. Also included is at least one groove disposed within at least one of the forward surface and the aft surface of the sealing strip.

According to another aspect of the invention, a seal assembly for a turbine system includes a plurality of sealing strips axially spaced from each other and disposed within a fluid path defined by a first component disposed proximate a rotor of the turbine system and a second component disposed proximate a turbine casing, wherein each of the plurality of sealing strips include a forward surface. Also included is at least one groove extending radially within the forward surface of each of the plurality of sealing strips for inhibiting a flow of fluid passing through the fluid path.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a partial cross-sectional view of a turbine system having a seal assembly;

FIG. 2 is a partial perspective view of the seal assembly having a sealing strip disposed between a first component and a second component;

FIG. 3 is a perspective view of a plurality of sealing strips; and

FIG. 4 is a perspective view of the sealing strip.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system.

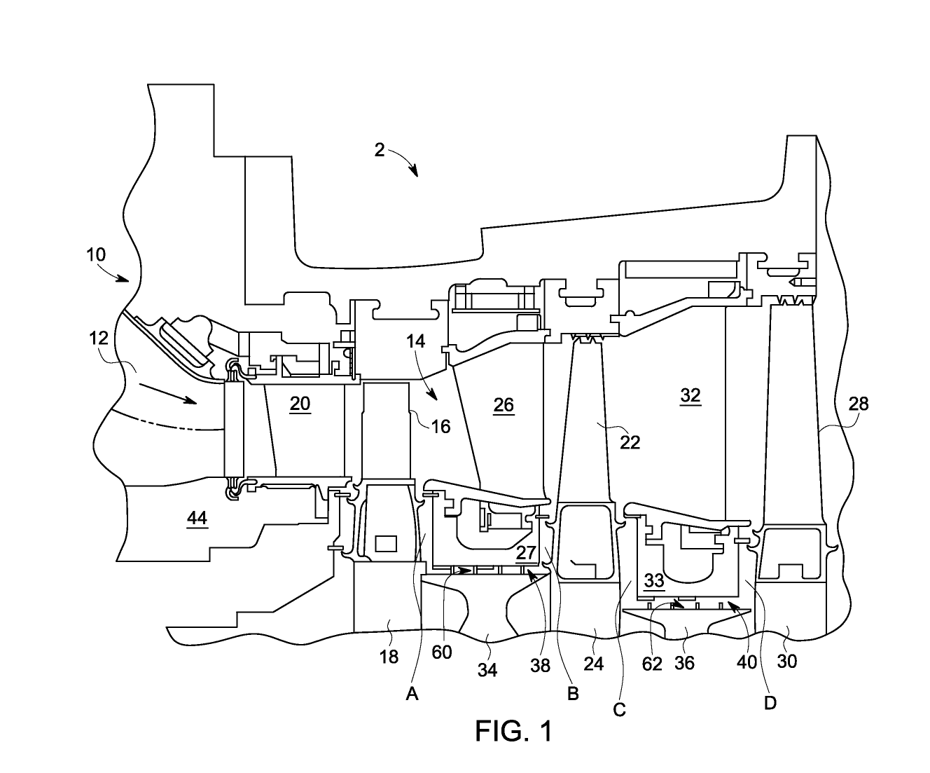

With reference to FIG. 1, a turbine system in accordance with an exemplary embodiment is generally illustrated with reference numeral 2. The turbine system 2 includes a turbine section 10 that receives hot gases of combustion from an annular array of combustors (not shown). The combustion gases pass through a transition piece 12 and flow along a hot gas path 14 toward a number of turbine stages (not separately labeled). Each turbine stage includes a plurality of circumferentially spaced blades and a plurality of circumferentially spaced stator vanes forming an annular array of nozzles. In the exemplary embodiment shown, the first stage of the turbine section 10 includes a plurality of circumferentially spaced blades, one of which is indicated at 16, mounted on a first-stage turbine rotor 18 and a plurality of circumferentially spaced-stator vanes, one of which is indicated at 20. Similarly, a second stage of the turbine section 10 includes a plurality of blades, one of which is indicated at 22, mounted on a second stage turbine rotor 24 and a plurality of circumferentially spaced stator vanes, one of which is indicated at 26. The turbine section 10 is also shown to include a third stage having a plurality of circumferentially spaced blades, one of which is indicated at 28, mounted on a third stage turbine rotor 30 and a plurality of circumferentially spaced stator vanes, one of which is indicated at 32.

At this point it should be appreciated that the number of stages present within the turbine section 10 may vary. The turbine section 10 also includes a plurality of spacers, two of which are indicated at 34 and 36, rotatably mounted between first, second, and third stage turbine rotors 18, 24 and 30. The spacers 34 and 36 are arranged in a spaced relationship relative to turbine casing members 27 and 33 to define channels 38 and 40, respectively. Finally, it should be appreciated that a cooling flow, such as compressor discharge air, is located in a region 44, which is then introduced into regions A and C and subsequently flowing to regions B and D, respectively, which are at lower pressures. Regions A and B are each at a higher pressure than the pressure of the hot gases flowing along the hot gas path 14 At this point it should be understood that the above-described structure is provided for the sake of clarity. The exemplary embodiment is directed to seal assemblies 60 and 62 arranged within the channels 38 and 40, respectively. The seal assemblies 60 and 62 constitute labyrinth seals that inhibit fluid flow passing from one side of the seal assemblies 60 and 62 to another, while also pressurizing the regions A and B to reduce introduction of the hot gas path 14 into the regions A and B. Fluid flow bypassing the turbine stages and passing from the hot gas path 14 will negatively affect an overall efficiency of the turbine system 2.

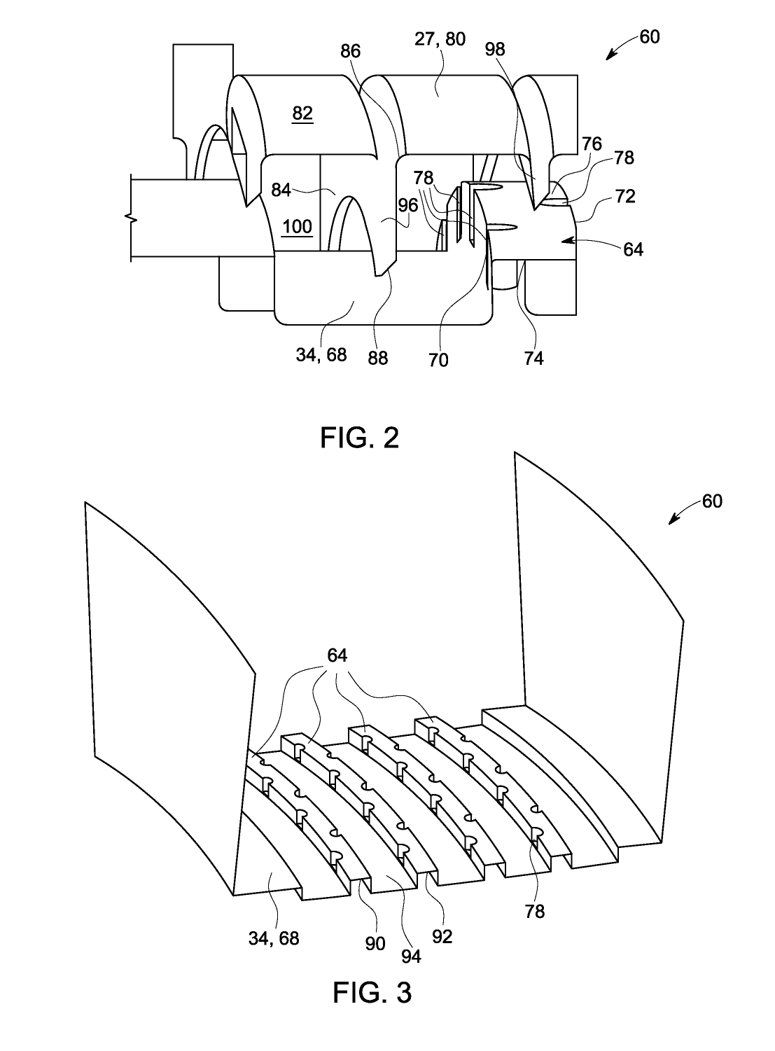

Referring now to FIGS. 2-4, each of the seal assemblies 60 and 62 are similarly formed. In describing the seal assembly 60, it is to be understood that the seal assembly 62 includes a corresponding structure, such that only the seal assembly 60 will be referred to in the description below. In accordance with an exemplary embodiment, the seal assembly 60 comprises a sealing strip 64, however, typically a plurality of sealing strips are included at various axially spaced locations. Each sealing strip is of similar structure. The sealing strip 64 is mounted directly to, or operably coupled to, a surface of a first component 68 that is rotatable, such as the spacer 34 described above with reference to FIG. 1. The sealing strip 64 may be mounted within a notch formed in the spacer 34 configured to accommodate the sealing strip 64 and/or may be fastened thereto. The first component 68 is moveable in a rotating manner that corresponds to rotational movement of a main rotor (not illustrated) disposed at a radially central location of the turbine section 10.

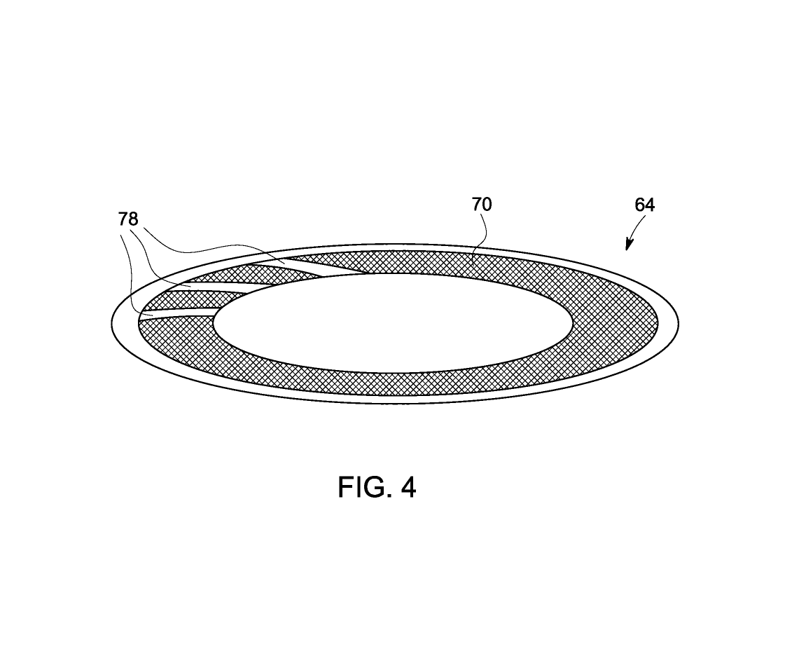

The sealing strip 64 extends circumferentially around, and radially outwardly from, the first component 68. Although illustrated in FIG. 4 as a single component, it is contemplated that the sealing strip 64 is formed of a plurality of segments arranged circumferentially adjacent to one another. Irrespective of the precise configuration, the sealing strip 64 includes a forward surface 70, an aft surface 72, a radially inner edge 74 and a radially outer edge 76. It is noted that the forward surface 70 is disposed upstream of the aft surface 72. The sealing strip 64 includes at least one, but typically a plurality of grooves 78 disposed within the forward surface 70 and/or the aft surface 72. As stated above, it is contemplated that one groove may be employed within the sealing strip 64, however, typically the plurality of grooves 78 are circumferentially arranged and the number will range from between about 30 and about 180. The plurality of grooves 78 extend radially within the sealing strip 64 and may be of various dimensions and shapes.

As described above, the sealing strip 64 extends radially outwardly from the first component 68. The sealing strip 64 extends toward a second component 80 that is mounted directly to, or operably coupled to, a stationary component, such as the turbine casing 27, or a stationary component extending radially inwardly from the turbine casing 27. The second component 80 includes a main surface 82 and at least one, but typically a plurality of planar protrusion members 84 that extend radially inwardly from the main surface 82 and are axially spaced from one another. Each of the plurality of planar protrusion members 84 extend from a first end 86 to various radial depths at a second end 88, as will be described in detail below. The second end 88 of the planar protrusion members 84 each form a generally shape. Each of the plurality of planar protrusion members 84 extend to varying lengths toward the first component 68 and the sealing strip 64.

As described above, the seal assembly 60 may include a plurality of sealing strips, such as a first sealing strip 90 and a second sealing strip 92 that is disposed axially spaced from, and adjacent to, the first sealing strip 90. The axial distance between the first sealing strip 90 and the second sealing strip 92 defines an axial region 94. A first planar protrusion member 96 extends into the axial region 94 and a second planar protrusion member 98 is axially aligned with, and extends radially toward the first sealing strip 90 or the second sealing strip 92. It is to be appreciated that any number of planar protrusion members and sealing strips may be employed in the seal assembly 60.

The first component 68 and the second component 80 define a fluid path 100 corresponding to the channel 38 described above for an embodiment comprising the spacer 34 and the turbine casing 27. Irrespective of the components defining the fluid path 100, it is to be appreciated that the seal assembly 60 is configured to inhibit fluid flow in the turbine system 2. The seal assembly 60 inhibits fluid flow by influencing the flow radially outwardly toward the second component 80 and creating restrictions for the fluid path 100, thereby increasing axial pressure drop throughout the fluid path 100. Although illustrated and described as being disposed between a stationary member and a moving member, the seal assembly 60 may be installed in locations between variable speed surfaces. Furthermore, while illustrated as functioning as a packing seal, the seal assembly 60 may be employed to inhibit flow between various other moveable surfaces, including surfaces that are moveable translationally, surfaces moveable relative to a static member or surfaces rotating at substantially similar speeds. That is, the seal assembly 60 may be installed in a variety of locations, including being employed as blade seals and inter-stage seals. It should further be appreciated that the seal assembly 60 may be installed in a wide range of turbine systems, including but not limited to gas turbine system and steam turbine systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A seal assembly for a turbine system comprising:
a sealing strip having a forward surface and an aft surface, wherein the sealing strip is operably coupled to a first component and extends radially outwardly toward a second component for inhibiting a flow of fluid passing through a fluid path defined by the first component and the second component; and
at least one groove disposed within at least one of the forward surface and the aft surface of the sealing strip.

2. The seal assembly of claim 1, wherein the first component is a moveable component.

3. The seal assembly of claim 2, wherein the first component is a rotating component.

4. The seal assembly of claim 1, wherein the second component is a stationary component.

5. The seal assembly of claim 1, wherein the seal assembly further comprises a plurality of sealing strips axially spaced from one another within the fluid path.

6. The seal assembly of claim 1, wherein the sealing strip comprises a plurality of grooves circumferentially spaced from each other.

7. The seal assembly of claim 6, further comprising from about 30 to about 180 grooves circumferentially spaced from each other within at least one of the forward surface and the aft surface of the sealing strip.

8. The seal assembly of claim 1, wherein the sealing strip is disposed proximate and surrounds a rotor of the turbine system.

9. The seal assembly of claim 1, wherein the second component is disposed proximate a turbine casing of a turbine section of the turbine system.

10. The seal assembly of claim 1, wherein the second component further comprises at least one planar projection extending radially inwardly toward the first component.

11. The seal assembly of claim 10, wherein the second component comprises:
a first planar projection extending into a region of the fluid path between the sealing strip and an adjacent sealing strip; and
a second planar projection extending into the fluid path at an axial location corresponding to at least one of the sealing strip and the adjacent sealing strip.

12. A seal assembly for a turbine system comprising:
a plurality of sealing strips axially spaced from each other and disposed within a fluid path defined by a first component disposed proximate a rotor of the turbine system and a second component disposed proximate a turbine casing, wherein each of the plurality of sealing strips include a forward surface; and
at least one groove extending radially within the forward surface of each of the plurality of sealing strips for inhibiting a flow of fluid passing through the fluid path.

13. The seal assembly of claim 12, wherein the first component is a moveable component.

14. The seal assembly of claim 13, wherein the first component is a rotating component.

15. The seal assembly of claim 12, wherein the second component is a stationary component.

16. The seal assembly of claim 12, wherein each of the plurality of sealing strips further comprises an aft surface having a plurality of grooves radially aligned therein.

17. The seal assembly of claim 12, wherein each of the plurality of sealing strips comprises a plurality of grooves circumferentially spaced from each other.

18. The seal assembly of claim 17, further comprising from about 30 to about 180 grooves circumferentially spaced from each other within the forward surface.

19. The seal assembly of claim 12, wherein the second component comprises:
a first planar projection extending into a region of the fluid path between a first sealing strip and an adjacent sealing strip; and
a second planar projection extending into the fluid path at an axial location corresponding to at least one of the first sealing strip and the adjacent sealing strip.

20. The seal assembly of claim 12, further comprising a plurality of grooves within the forward surface and an aft surface of each of the plurality of sealing strips.
